(19) United States
(12) Patent Application Publication
(10) Pub. No.: US 2003/0038438 A1
(43) Pub. Date: Feb. 27, 2003

(54) Trolley

(76) Inventor: Allert Harm Maarten Van Oosten, Queensland (AU)

Correspondence Address: SHOEMAKER AND MATTARE, LTD., Crystal Plaza Building 1 - Suite 1203, 2001 Jefferson Davis Highway, Arlington, VA, 22202, US

(21) Appl. No.: 09/935,052

(22) Filed: Aug. 23, 2001

(51) Int. Cl. B62B 1/00

(52) U.S. Cl. 280/79.6; 280/652

(57) ABSTRACT

A trolley for conveying rolls of carpet and the like has a carriage including a cradle which can be tilted from a transport position to a loading position.

### FIELD OF THE INVENTION

This invention relates to a trolley, in particular but not limited, to a trolley for transporting and dispensing from, rolls of soft floor covering material such as carpet and vinyl.

The invention will be described generally in relation to movement of a carpet roll but it will be appreciated that a trolley according to the invention can be employed for moving other loads. The expressions “trolley” and “cart” are synonymous in this specification.

Manufacturers supply carpets in continuous lengths of various widths and gauges wound onto a supporting hollow central core. The standard and most relevant of these is the 12 foot (3.66m) broadloom width. Full rolls in this category can weigh between 250 lb to 1200 lb (100 kg to 600 kg) with a girth diameter in the range of between 1½ feet to 3 feet (500 mm to 850 mm). Carpets are generally perceived to be soft and warm to touch and are constructed from combinations of intermingled organic and mineral fibres. Other rolled floor coverings typically include: padding or underlay, weatherproof, melded fibre, rubber back, foam rubber back, linoleum, vinyl, PVC or rubber and protective films. Due to the bulky nature of these materials, it is preferable to employ specialist equipment for safe handling and transportation of full rolls. Various types of standard and purpose built trolleys are commonly available for this task. These usually include additional mechanical devices to help the operator lift a roll. Such mechanical devices may include: carpet. hoists, cranes, and fork lift trucks, etc.

A carpet or vinyl roll is usually too big for one person to safely move without the aid of a trolley. Carpet trolleys are in common use and have been for many years. Carpet trolleys have not been improved and new trolleys have not been devised over the many years that the existing trolleys have been in use. In almost all prior art trolleys the roll of carpet or vinyl floor covering has to be lifted and placed on the trolley. This is a physically strenuous activity which can result in industrial accidents especially back injuries.

In the absence of lifting equipment, an operator can reduce the risk of injury when manually lifting a roll by expending as much labour as is deemed safe, relevant to the weight of the roll. Manually lifting a roll to the height of a trolley e.g. to a height of 2 feet (600 mm) imposes some risk of injury. Rolled carpet can also be pushed and drop loaded onto a trolley from a vehicle. This technique however, is not recommended as it can damage the trolley or injure operators or bystanders.

Further handling of material may entail, transporting the roll over a short distance, e.g. loading zone to front door, orientation, positional adjustments and storage of the carpet roll on and around the job site before installation. The installer may also attempt to drag, hand or shoulder carry the roll. The risk of injury is greatly increased when the roll is manually lifted and carried over a given distance.

### OBJECT OF THE INVENTION

An object of the present invention is to seek to ameliorate or overcome the limitations and disadvantages of prior art trolleys or to at least provide the public with a useful choice.

### SUMMARY OF THE INVENTION

In one aspect the present invention resides in a trolley able to carry an elongate body, the trolley having a carriage including a cradle for supporting the elongate body, the cradle being offset laterally, the cradle and carriage being tiltable together between a transport position where the elongate body can be supported for transport and a tilted loading position whereby said elongate body can be loaded onto the cradle as the cradle is moved between the tilted loading position and the transport position, the carriage being supported by a wheel assembly having spaced wheels.

Preferably, the cradle and carriage tilt together between the tilted and loading positions. Preferably, the trolley employs a loader particularly when the trolley is configured for single user operation, in the form of a flexible strap that passes around an elongate body to aid loading of the elongate body onto the tilted cradle.

The carriage typically comprises at least one transverse member supported by laterally spaced wheels or rollers.

Preferably there is also provided a mountable carriage adapted for attaching to the at least one transverse member having one or more wheels of substantially greater diameter than the laterally spaced wheels or rollers, the mountable carriage adapted to provide greater ground clearance and to facilitate easier transport of the trolley over uneven terrain.

The cradle preferably comprises longitudinally spaced apart supports. The supports are at opposite ends of the trolley with a third support typically centrally located. More supports maybe employed.

In another version the end supports are preferably positioned at or adjacent the ends of respective arms which pivot from the carriage from storage to an operating position. The arms are preferably foldable and are typically of unequal length to facilitate compact folding.

The cradle is offset preferably by positioning the arms to one side on the carriage. Each support is preferably curved having respective marginal side sections of the cradle or its support able to be positioned generally in a ramp configuration when the cradle is in the tilted loading position.

Preferably there are roller assemblies which can be attached to the trolley adapted to enable the elongate body, typically a roll of vinyl or other floor covering, to rotate on the roller assemblies for dispensing layers from the vinyl or other floor covering from the trolley.

There can be one or more ground engaging castor wheels attached to the roller assemblies to provide levelled support for the roll to facilitate the dispensing action. Preferably the castor wheels have a braking mechanism to prevent the trolley from moving, creeping or pivoting in a horizontal plane about a vertical axis when vinyl or other floor covering material is dispensed in layers from the roll on the trolley.

Preferably, there are handle means which can be attached to the trolley to facilitate pulling or pushing the trolley with ease.

The loader is preferably one or more straps or other means that can be used to promote an elongate body onto the cradle as the cradle is manually levered from the tilted position to the transport position.

Preferably, the loader is a single strap secured to the carriage or the central support near the cradle offset side of the carriage.

The relative dimensions of the carriage and cradle are preferably chosen to provide a low centre of gravity assembly for a stable trolley with the ability to be loaded using a tilt operation.

### BRIEF DESCRIPTION OF THE DRAWINGS

In order that the present invention can be more readily understood and be put into practical effect, reference will now be made to preferred embodiments of the invention and wherein

FIG. 1 is a perspective view illustrating a trolley of the present invention according to Example 1;

FIG. 2 is a perspective view illustrating a second embodiment of a trolley of the present invention configured with a strap loader for single user operation according to Example 2;

FIG. 3 is a perspective view illustrating the trolley of FIG. 2 in the tilted loading position;

FIGS. 4 and 5 illustrate the various stages of loading;

FIG. 6 is a perspective drawing illustrating a further embodiment showing the trolley in a folded storage position;

FIGS. 7 and 8 show side and end elevation views of a trolley according to Example 1 or Example 2 with a handle;

FIGS. 9 and 10 show details of roller assemblies attachable to a trolley according to Example 4;

FIGS. 11 and 12 show loading and transporting of a carpet roll on the trolley of Example 4;

FIGS. 12a and 12b show a roll on and being dispensed from a trolley with roller assemblies;

FIGS. 13 and 14 show a preferred mountable carriage for attaching to a trolley according to Example 5; and

FIG. 15 show the mountable carriage of Example 5 in a storage position.

### DETAILED DESCRIPTION OF THE DRAWINGS

### EXAMPLE 1

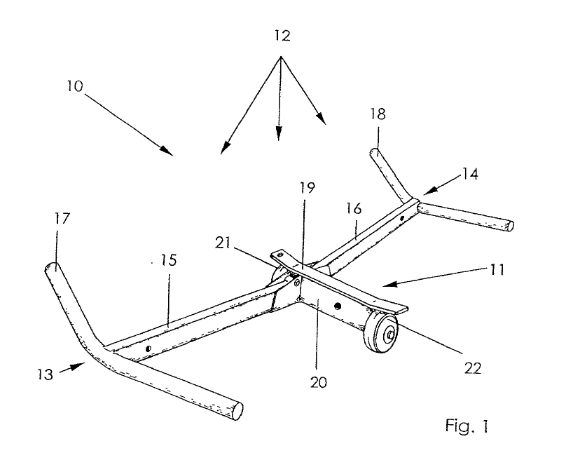

Referring to the drawings and initially to FIG. 1, there is illustrated a trolley 10 able to carry an elongate body by reason of the trolley 10 having a carriage 11 supporting a cradle 12, in this case comprised of arms 13 and 14 employing elongate members 15 and 16 equipped with end supports in the form of curved cross bars 17 and 18.

The carriage 11 also has a central support bar 19 fitted atop a main support beam 20 which carries on through axles respective wheels 21 and 22. As can be seen the cradle comprising the arms 13 and 14 is offset laterally toward the wheel 21 to facilitate sideways tilting. In this case the carriage and cradle tilt as a unit and the trolley is balanced so that it will tilt and stand in its titled loading position by itself.

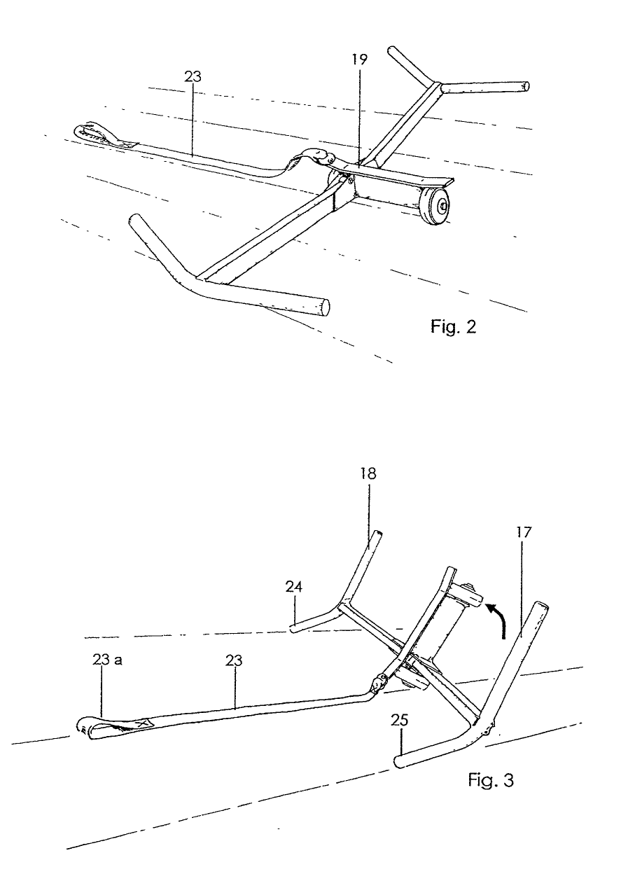

The cradle is therefore effectively tiltable between the transport position (FIGS. 1 and 2) and a tilted loading position (FIGS. 3, 4 and 5) whereby an elongate body, say a carpet roll can be loaded onto the cradle as the cradle is moved between the tilted loading position and the transport position.

The loading process can be easily undertaken by a single person since all that is required is to promote the body slightly onto the cradle sufficient for the levering action of the carriage to accomplish the final loading.

### EXAMPLE 2

Referring now to FIG. 2, like numerals have been used to illustrate like features but it will be appreciated that in FIG. 2, a loader in the form of a strap 23 is secured to the support bar 19 at the cradle offset side of the carriage so that the embodiment of FIG. 2 is configured for single operator use using the strap to promote the body onto the cradle. FIG. 2 shows the trolley in position prior to tilting.

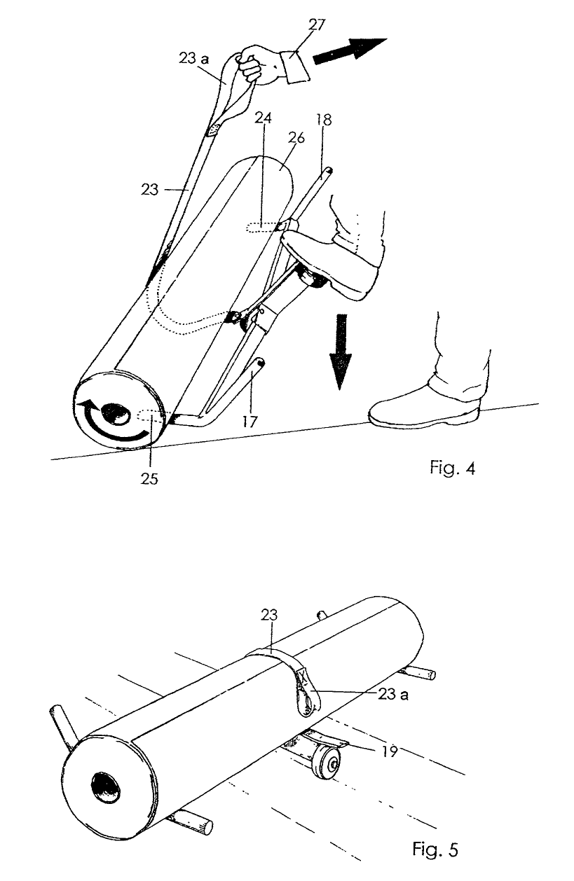

The trolley is moved to the tilted position in FIG. 3 and it will be appreciated that the end sections 24 and 25 of cross bars 17 and 18 are located generally as ramps and that sideways rolling of a carpet roll onto end sections 24 and 25 under the influence of the strap 23 that a single user will be able to load a carpet roll onto the trolley. This process is illustrated in FIGS. 4 and 5.

In FIG. 4 the trolley is shown with a carpet roll 26 rolled onto the projecting end sections 24 and 25 of the cross bars 17 and 18. While the trolley itself is being used as a lever and at the same time the strap 23 is being pulled on by the operator in the position 27 illustrated in FIG. 4 to finally move the trolley and carpet roll to the position illustrated in FIG. 5. The whole process is a dynamic process and although the drawings are static it will be appreciated that they serve to merely illustrate this rolling, pulling an levering action which all happens in one motion to effect loading. The loop 23a of the strap 23 may be changed so that the strap 23 can be used for tying the carpet roll down to the trolley once it is loaded.

For example in such cases the opposite end of the crossbar 19 could include a strap section with say a side release buckle or other tensioning arrangement on short length of strapping so that the carpet roll may be secured in position on the trolley. Although the trolley is loaded from the side it is usually pushed around by pushing on one end of the carpet roll.

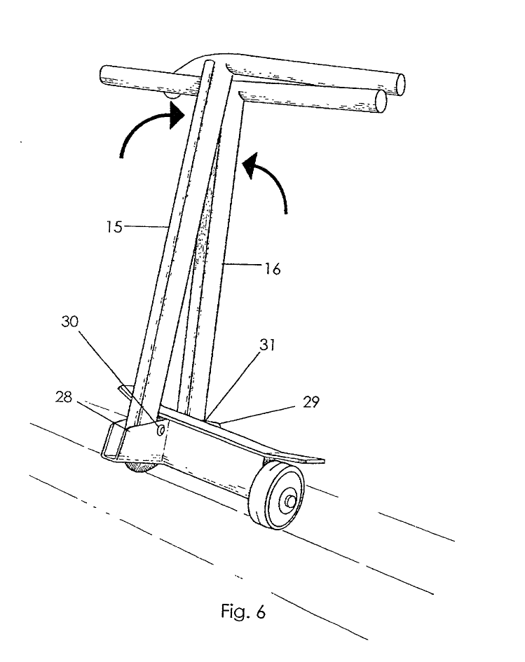

Referring now to FIG. 6, as can be seen the arms 15 and 16 are of different length to facilitate folding to the position illustrated in FIG. 6. Each of the arms 15 and 16 are mounted to the carriage by mounting brackets 28 and 29 respectively with hinge pin couplings 30 and 31. In FIG. 6 the trolley is shown in its folded storage position.

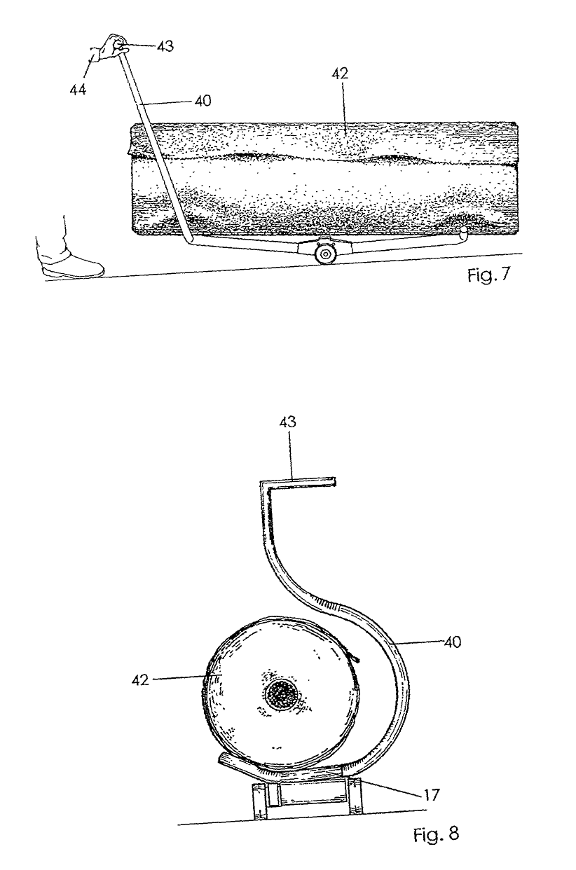

Referring now to FIGS. 7 and 8 there is shown a preferred handle 40 of an S-configuration which is removably attachable to one of the supports 17 of the trolley. The handle has an S-shape to accommodate a carpet roll 42 and to provide a hand grip 43 in a central position for a user 44 to pull or push the trolley carrying the carpet roll.

### EXAMPLE 3

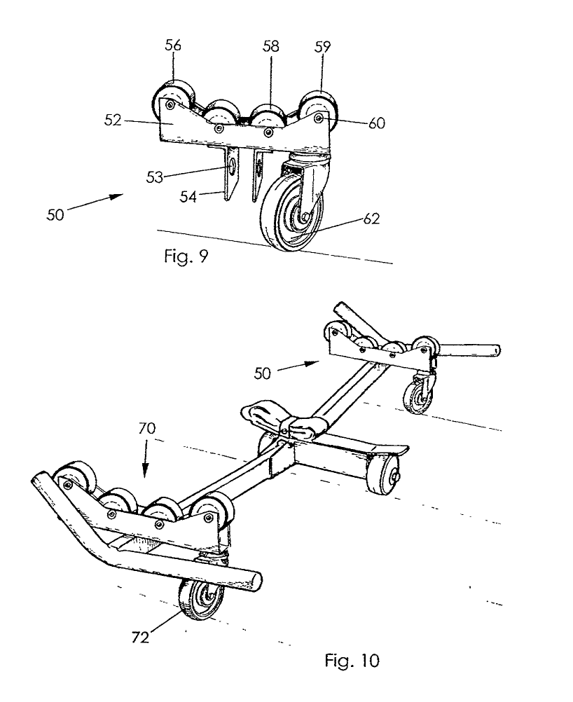

Referring to FIGS. 9 and 10 there is shown detail of roller assemblies 50, 70 which can be attached to a trolley according to Example 3. The roller assembly comprises a roller housing member 52 with a bracket member 54 for attachment to the arms of a trolley. The bracket preferably has a bolt hole 53 for attaching to the arm of a trolley by means of a bolt and wing nut. Preferably the roller housing member 52 is a U-shaped metal chassis supporting two or more free wheeling rollers 56, 58, 59 having bush or ball bearings on an axle pin 60.

The housing is preferably supported by a ground engaging swiveling castor wheels 62, 72 adapted to enable rolls of floor covering (not shown) to be supported on the rollers. This enables the roll of floor covering material to rotate on the rollers and be dispensed in layers from a level position on the trolley.

The castor wheel preferably has a braking mechanism to stop the trolley from moving or pivoting when layers are dispensed from the trolley. In the alternative, the castor wheel and brake mechanism can be replaced by a retractable support stand.

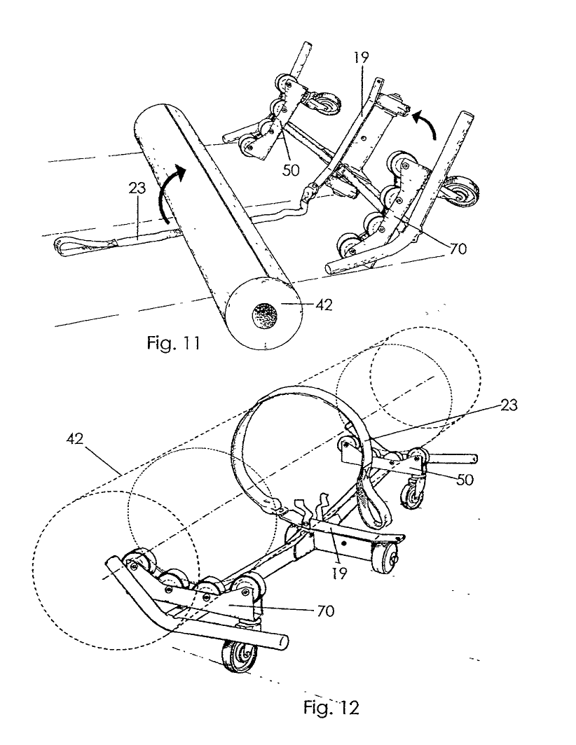

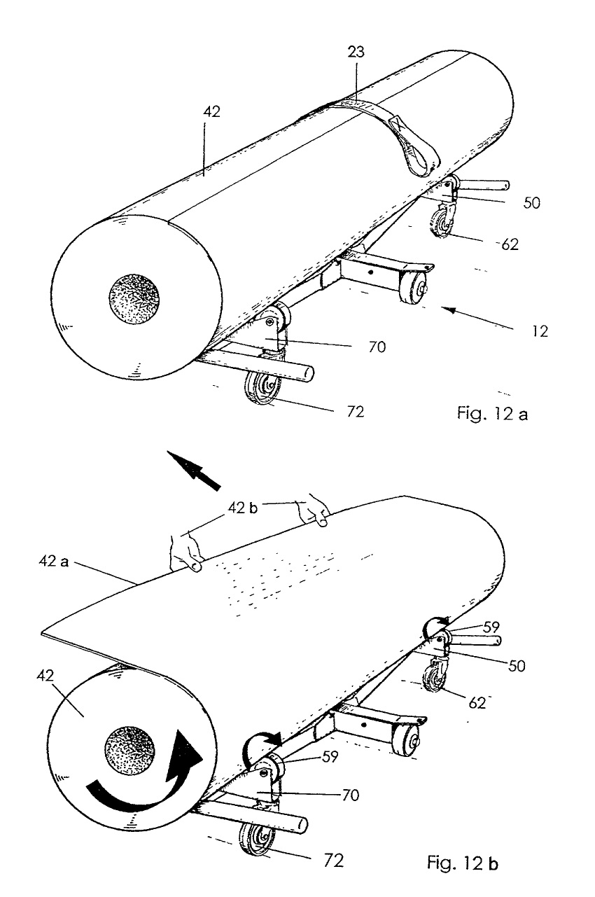

FIG. 11 shows a roll of floor covering 42 being loaded on a trolley according to Example 3 wherein the trolley is in a tilted position and the roll is rolled towards the trolley and to engage the rollers 50, 70. By pulling on the strap loader 23 as previously described, a single operator can load the roll and tilt the trolley back into a transport position as shown in FIG. 12. The loading strap can be used to secure the roll (shown in phantom) to the trolley.

Referring to FIG. 12a there is shown a roll 42, typically a vinyl roll in a transport position on a trolley 12 with roller assemblies 50, 70. The roller assemblies have castor wheels 62, 72 to provide levelled support for the roll for dispensing purposes.

FIG. 12b shows the vinyl roll 42 of FIG. 12a being dispensed from the trolley. In order to dispense layers from the roll, an operator simply pulls 42b on the free edge and causing the roll to rotate on the rollers 59 of the roller assemblies 50, 70. The castor wheels 62, 72 are preferably braked by activating braking mechanisms (not shown) to prevent the trolley from creeping or pivoting in a horizontal plane about a vertical axis.

### EXAMPLE 4

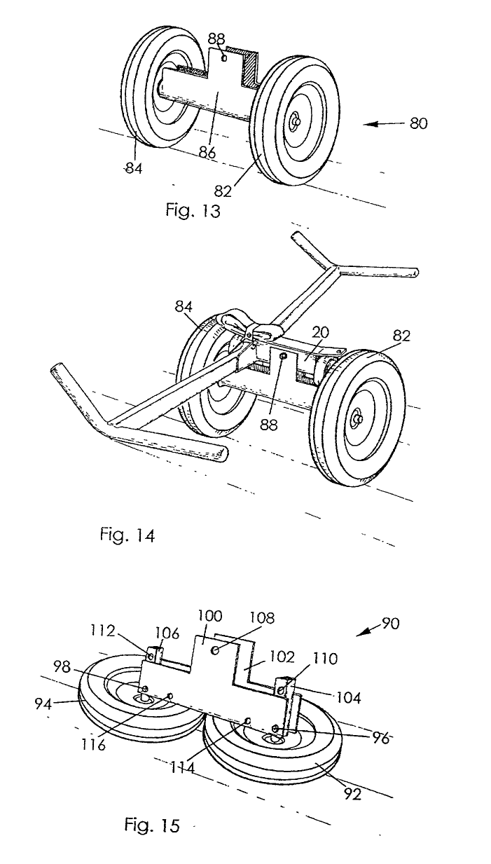

FIGS. 13 and 14 show a perspective view of a wheeled mountable carriage 80 for attaching to the trolley by means of a single bolt. The pneumatic wheels 82, 84 of the mountable carriage member are of a larger diameter than the wheels or rollers of the trolley to enable rolls of carpet (not shown) to be more easily transported over uneven or rough ground. The construction of the mountable carriage comprises a T-shaped chassis 86 of a steel plate bent over an axle rod. There is shown a bolt hole 88 in the T-shaped chassis for attaching to the main support beam 20 of the trolley.

### EXAMPLE 5

FIG. 15 shows a modification of the mountable carriage member 90 according to Example 5 wherein the wheels 92, 94 can be pivoted about a bolt 96, 98 or pin so that the wheels can be lain flat in a storage position. In this modification, the T-shaped chassis comprises separate plate members 100, 102 which house pivoting stub axles 104, 108 between them. King pins or bolts 96, 98 provide pivot points for the stub axles as well as hold the plate members together. The T-shaped chassis is attached to the trolley by means of a bolt and wing nut through the hole 108 and a corresponding hole 20 in the main support beam of the trolley as shown in FIG. 1. The wheels are preferably pneumatic wheels which are located on the stub axles by a split pin and washer assemblies. The wheels are pivoted upright into an operating position and are locked in place by bolts passing through the holes 110, 112 in the stub axles and the holes 116, 114 in the chassis plate members.

This modification is an advantage where the mountable carriage has to be stored in a carpet laying truck where there is limited space.

Whilst the above has been given by way of illustrative example of the present invention many variations and modifications thereto will apparent to those skilled in the art without departing form the broad ambit and scope of the invention as herein set forth.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

The claims defining the invention are as follows:

1. A trolley adapted to carry an elongate body, the trolley having a carriage including a cradle for supporting the elongate body, the cradle being offset laterally, the cradle and carriage being tiltable together between a transport position where the elongate body can be supported for transport and a tilted loading position whereby said elongate body can be loaded onto the cradle as the cradle is moved between the tilted loading position and the transport position, the carriage being supported by a wheel assembly having spaced wheels.

2. A trolley as claimed in claim 1, wherein the cradle and carriage tilt together between the tilted loading position and the transport positions.

3. A trolley as claimed in claim 1, wherein the trolley employs a loader for single user operation in the form of flexible strap that passes around the elongate body to aid loading of the elongate body onto the tilted cradle.

4. A trolley as claimed in claim 1, wherein the cradle includes longitudinally spaced apart supports.

5. A trolley as claimed in claim 1, wherein the cradle comprises longitudinally spaced apart supports at opposite ends of the trolley with a third support located substantially in the middle of the trolley.

6. A trolley adapted to carry an elongate body, the trolley having a carriage including a cradle for supporting the elongate body the cradle comprising one or more foldable arms adapted to pivot off the carriage from a storage to an operating position, the cradle being offset laterally, the cradle and carriage being tiltable together between a transport position where the elongate body can be supported for transport and a tilted loading position whereby said elongate body can be loaded onto the cradle as the cradle is moved between the tilted loading position and the transport position, the carriage being supported by a wheel assembly having spaced wheels.

7. A trolley as claimed in claim 6, wherein the foldable arms are of unequal length to facilitate compact folding.

8. A trolley as claimed in claim 6, wherein there are supports positioned adjacent the ends of the foldable arms.

9. A trolley as claimed in claim 6, wherein the cradle is offset and has foldable arms positioned to one side of the carriage.

10. A trolley as claimed in claim 1 or in claim 6 wherein there are roller assemblies which can be attached to the trolley adapted to enable the elongate body, typically a roll of carpet or other floor covering, to rotate on the roller assemblies for dispensing the carpet or other floor covering from the trolley.

11. A trolley as claimed in claim 10 wherein there can be one or more ground engaging castor wheels attached to the roller assemblies to provide levelled support for dispensing from the rolls of carpet or other material.

12. A trolley as claimed in claim 10 wherein there can be one or more ground engaging castor wheels having a braking mechanism to prevent the trolley from moving or tilting when carpet or other rolled material is dispensed from the trolley.

13. A trolley as claimed in claim 1 or claim 6 wherein there are handle means which can be attached to the trolley to facilitate pulling or pushing the trolley with ease.

14. A trolley as claimed in claim 1 or claim 6 wherein the relative dimensions of the carriage and cradle are preferably chosen to provide a low centre of gravity assembly for a stable trolley with the ability to be loaded using a tilt operation.
